(19) United States
(12) Patent Application Publication
(10) Pub. No.: US 2025/0067306 A1
(43) Pub. Date: Feb. 27, 2025

(54) ROLLING-ELEMENT BEARING COMPRISING HOLES AND GROOVES

(71) Applicant: AKTIEBOLAGET SKF, GOTEBORG (SE)

(72) Inventors: Christophe Serge Jean Yves HOUDAYER, Semblancay (FR); Yannick Sébastien SARTON, Luynes (FR)

(21) Appl. No.: 18/806,862

(22) Filed: Aug. 16, 2024

(30) Foreign Application Priority Data
Aug. 25, 2023 (DE) 102023208145.8

(51) Int. Cl. F16C 43/04; F16C 33/58

(52) U.S. Cl. CPC F16C 43/04; F16C 33/583

(57) ABSTRACT

A rolling-element bearing includes inner and outer rings each having axially spaced end faces. The outer ring has a cylindrical outer side surface having a longitudinal mark separated from a hole in one axial end face of the outer ring by a first angle. The inner ring has a cylindrical inner surface having a longitudinal mark separated from a hole in one axial end face of the inner ring by a second angle. The hole of the outer bearing ring and the hole of the inner bearing ring are separated by a third angle γ when the longitudinal mark of the outer bearing ring and the longitudinal mark of the inner bearing ring are contained in a same longitudinal plane passing through the longitudinal axis. Also a method that includes placing pins in the holes to align the inner and outer rings with adjacent structures.

### CROSS-REFERENCE

This application claims priority to German patent application no. 10 2023 208 145.8 filed on Aug. 25, 2023, the contents of which are fully incorporated herein by reference.

### TECHNOLOGICAL FIELD

The present disclosure is directed to the field of rolling-element bearings, and, more specifically, to the field of large diameter rolling-element bearings having an inner ring and an outer ring arranged concentrically about an axis of rotation that extends in an axial direction that may be used for example in marine applications, for example in a tidal or marine turbine power station, or in a tunnel boring machine, or in a mining extraction machine, or in a wind turbine.

### BACKGROUND

A large diameter rolling-element bearing generally comprises concentric inner and outer rings and at least one row of rolling elements, such as rollers or balls, arranged between the rings. The bearing also comprises seals disposed between the inner ring and the outer ring to define a closed space inside which the rolling elements are arranged.

Large diameter rolling-element bearings are generally used in aggressive environments, especially in marine applications. Seals prevent exterior elements, such as dust, abrasive particles, water, and marine species, for example plankton and algae, from getting inside the bearing and damaging its components. Those exterior elements may also alter the seal itself, leading to a reduction in the service life of the seal.

Generally, a plurality of additional adjacent seals are provided on the bearing front side which is directly in contact with the aggressive environments, for example with the saltwater. These additional seals are fixed to a sealing ring of one of the inner and outer rings and comprise a sealing lip in sliding contact with a running surface of a sealing ring of the other ring. Hence, several adjacent closed outer chambers are delimited between the sealing lips of the adjacent seals.

If water starts to enter inside the rolling-element bearing, by first entering inside the first outer seal chamber, it is desired to prevent the water or pollution to move further inside the bearing and reaching the rolling space. Water ingress can occur in most of applications, but is a particular problem for immerged applications such as in tidal turbines.

In a general way, the sealing rings are designed to optimize sealing and to facilitate seal maintenance. Accordingly, in certain types of design, all or most sealing rings comprise one or many leakage test channels.

Prior to use of the rolling-element bearing, a leakage test channel enables a fluid to be introduced in an area where a seal is located. Hence, the efficiency of the sealing members and the seals may be tested. The introduced fluid may be compressed air, lubricant, colored liquid, etc.

A closing plug may be attached at an inlet orifice and/or at an outlet orifice of the leakage test channel by any appropriate means, for example by screwing. Preferably, the closing plug is made of transparent material to allow for visual detection of a contaminant fluid during an inspection of the rolling-element bearing. The closing plug may be covered by potting material and embedded inside this material. Hence, the associated thread of the closing plug is sealed.

The rolling-element bearing presented above works well and gives satisfaction. However, it has some drawbacks.

First, the rolling-element bearing structure is complex, and its implementation in a device, or between devices, can be complicated. It is also difficult to orientate the outer ring with a part of a device and to orientate the inner ring with another part of a device. Maintenance of the bearing can also be complicated because it is necessary to precisely position the outer ring or the inner ring with respect to a component or to precisely position the two rings relative to each other. This results in other disadvantages such as quite a high cost and a fairly long assembly time.

### SUMMARY

The present disclosure is intended, among other things, to overcome these drawbacks and seeks to optimize the rolling-element bearing installation by making it simpler. As a corollary, the disclosure is intended to reduce assembly times and to facilitate maintenance.

The disclosure relates to a rolling-element bearing comprising an outer ring and an inner ring capable of rotating concentrically relative to one another about a longitudinal axis and including at least one row of rolling elements arranged between the outer ring and the inner ring, the rolling-element bearing being provided with a first external face and a second external face axially opposite the first external face which faces delimit the axial length of the bearing.

The outer ring has a longitudinal hole opening out at the first external face of the rolling-element bearing, and at least one edge of the outer ring has a longitudinal mark, the hole and the mark of the outer ring being separated by a first angle α. When the mark and the hole are aligned they may be described as being separated by an angle of 0°.

The inner ring has a longitudinal hole opening out at the second external face of the rolling-element bearing, and at least one edge of the inner ring has a longitudinal mark, the hole and the mark of the inner ring being separated by a second angle β.

The hole of the outer ring and the hole of the inner ring are separated by a third angle γ when the marks of the outer ring and the inner ring are contained in a same longitudinal plane passing through the longitudinal axis.

The first angle α and the second angle β are measured according to the same direction of rotation, and the third angle γ is β minus a. Because the first angle α and the second angle β are known, the third angle γ is also known. Accordingly, two pins each placed in a hole are separated by the known third angle γ. In other words, it is enough to place all the marks of the rings in the same plane to adjust the distance between the pins. As a result, the placing of each ring on a part of a device is easier. Effectively, each pin has a protruding part which takes place in a hole of the device. The two holes which receive the protrusions of the pins are offset by the value of the third angle γ. This allows easy positioning of the outer and inner rings in a device. Thanks to the holes with pins, the angular position of the outer and inner rings is correct. Among the resulting advantages are easier and faster installation of the rolling-element bearing, easier maintenance and lower costs.

In one embodiment, the outer ring comprises at least a first bearing ring and at least one first sealing ring secured to the first bearing ring, the inner ring comprising at least one second bearing ring and at least one second sealing ring secured to the second bearing ring. This makes it possible to reinforce the sealing of the bearing.

The first sealing ring of the outer ring is formed as a split ring and comprises at least two ring parts, the ring part farthest from the bearing ring being an end ring, each ring part having a longitudinal through hole located on a first diameter Φ1, an outer peripheral edge of each ring part having a longitudinal mark, the through hole and the mark of the outer peripheral edge being separated by the first angle α, the first bearing ring of the outer ring having a longitudinal through hole located on the first diameter Φ1, an outer peripheral edge of the first bearing ring having a longitudinal mark, the through hole and the mark of the outer peripheral edge being separated by the first angle α, all of the through holes in the ring parts and the through hole in the first bearing ring being aligned and forming the hole opening out at the first face of the rolling-element bearing when all the marks of the ring parts and the first bearing ring are aligned. As a result, a pin prevents all rings from rotating relative to each other when the pin is in place in the hole opening out at the first face of the rolling-element bearing.

Two of the ring parts are twin rings having the same design, each twin ring having two longitudinal through holes, the two through holes being on the first diameter Φ1 and being separated by the third angle γ, each twin ring having a first mark at the level of one of the through holes and a second mark at the level of the other of the through holes, the twin rings being adjacent and offset. This simplifies the structure of the rolling-element bearing.

The end ring of the first sealing ring has a radial mark contained in a longitudinal plane passing through the longitudinal axis, the longitudinal plane containing the mark of the outer peripheral edge of the end ring. This allows one to see the position of the end ring from several different points of view.

The first sealing ring of the outer ring includes five ring parts. Very good operation was obtained with this number of rings, in particular for sealing the rolling-element bearing.

The second sealing ring of the inner ring has one longitudinal mark, and the second bearing ring of the inner ring has one longitudinal mark, the longitudinal marks being contained in a longitudinal plane passing through the longitudinal axis, the hole opening out at the second face of the rolling-element bearing being on a second diameter @2, the hole and the two longitudinal marks being separated by the second angle β. Accordingly, the position of a pin in place in the hole opening out at the second face is known.

The second sealing ring of the inner ring has a radial mark contained in the longitudinal plane which contains the longitudinal marks. This allows one to see the position of the second sealing ring from several different points of view.

The value of the first angle α is 0°, the value of the second angle β is 3°, and the value of the third angle γ is 3°. With these values, very good results have been obtained.

The disclosure is also directed to a mounting method of a rolling-element bearing presented above, the method comprising the following steps: placing a pin in the longitudinal hole of the outer ring so that the pin protrudes, placing another pin in the longitudinal hole of the inner ring so that the pin protrudes, positioning the outer ring relative to the inner ring so that their respective marks are contained in a same longitudinal plane passing through the longitudinal axis, securing one of the outer and inner rings to a rotating device, the projecting part of a pin extending into an orifice of the device, securing the other of the outer and inner rings to another rotating device, the projecting part of the pin extending into an orifice of the device.

### BRIEF DESCRIPTION OF THE DRAWINGS

The present disclosure and its advantages will be better understood by studying the detailed description of specific embodiment given by way of non-limiting example and illustrated by the appended drawings on which:

FIG. 1 is a partial perspective view from a side of a first external face of a rolling-element bearing, according to an embodiment of the disclosure.

FIG. 2 is a partial perspective view from a side of a second external face of the rolling-element bearing of FIG. 1, the second external face being opposite the first external face.

FIG. 3 is a partial perspective view of the rolling-element bearing of FIGS. 1 and 2 showing the second external face and inner edges.

FIG. 4 is a partial sectional view of the rolling-element bearing of FIGS. 1, 2 and 3.

FIG. 5 is a schematic side elevational view showing the rolling element bearing according to claim 1 positioned between two structures to which the rolling-element bearing is attachable.

### DETAILED DESCRIPTION

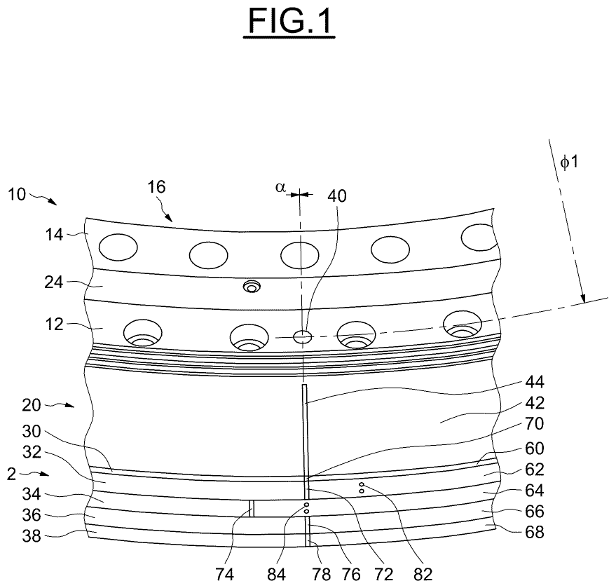

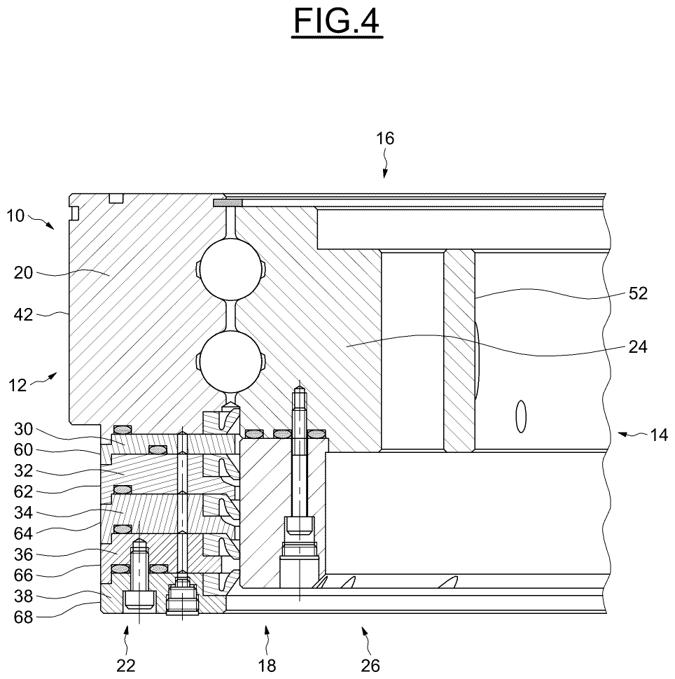

The rolling-element bearing 10 as illustrated in FIGS. 1-4 is a large diameter rolling-element bearing comprising a first ring 12 and a second ring 14. In the illustrated example, the first ring 12 is an outer ring and the second ring 14 is an inner ring. The rolling-element bearing may for example be used in a tidal or marine turbine power station, a tunnel boring machine, a wind turbine, a big offshore crane, or any other applications using a large diameter rolling-element bearing.

The outer and inner rings 12, 14 are concentric and extend axially along the bearing rotation axis, not shown, which runs in an axial direction. In the illustrated example, the rings 12, 14 are of the solid type, and the rolling-element bearing 10 extends longitudinally between a first external face 16 and a second external face 18 opposite to the first external face 18.

The outer ring 12 comprises a bearing ring 20 and a sealing ring assembly 22 secured to the bearing ring 20. The inner ring 14 also comprises a bearing ring 24 and a sealing ring assembly 26 secured to the bearing ring 24. The sealing ring assembly 22 of the outer ring 12 radially surrounds the sealing ring assembly 26 of the inner ring 14. Accordingly, the first external face 16 is delimited partly by the bearing ring 20 of the outer ring 12 and partly by the bearing ring 24 of the inner ring 14. The bearing ring 20 and the bearing ring 24 are optionally flush or offset axially. In the same spirit, the second external face 18 is delimited partly by the sealing ring assembly 22 of the outer ring and partly by the sealing ring assembly 26 of the inner ring 14. The sealing ring assembly 22 and the sealing ring assembly 26 are optionally flush or offset axially.

A plurality of successive seals, not individually referenced, is provided radially between the sealing ring assemblies 22, 26.

In the illustrated example, the rolling-element bearing 10 also comprises two rows of balls, not referenced, which are arranged between first bearing rings of the bearing ring 20 of the outer ring 12 and second bearing rings of the bearing ring 24 of the inner ring 14.

The sealing ring assembly 22 of the outer ring 12 is mounted axially against the bearing ring 20 and protrudes axially from the bearing ring 20. The sealing ring assembly 22 is reversely attached or secured to the bearing ring 20. The sealing ring assembly 22 radially surrounds the sealing ring assembly 26 of the inner ring 14. Each of the sealing ring assemblies 22, 26 may be made of stainless steel or treated steel with a painting or anti-corrosion treatment.

In the illustrated example, the sealing ring assembly 22 is formed as a split ring and comprises a first ring part 30, a second ring part 32, a third ring part 34, a fourth ring part 36 and a fifth ring part 38 stacked axially relative to one another. Alternatively, the sealing ring assembly 22 can include more or fewer ring parts. The fifth ring part 38 is an end ring, and the second ring part 32, the third ring part 34 and the fourth ring part 36 are intermediate rings.

The first ring part 30 is reversely secured to the bearing ring 20 by screws, not shown, spaced apart in the circumferential direction. The first ring part 30 axially abuts against the bearing ring 20. Similarly, the second ring part 32 is reversely secured to the first ring part 30 by screws, not shown, axially on the side opposite to the bearing ring 20. The third ring part 34 is reversely secured to the second ring part 32 by screws axially on the side opposite to the first ring part 30. The fourth ring part 36 is reversely secured to the third ring part 34 by screws axially on the side opposite to the second ring part 32. The fifth ring part 38 is reversely secured to the fourth ring part 36 by screws axially on the side opposite to the third ring part 34. The heads of the screws of the first ring part 30 may be covered by potting material and embedded inside this material. Hence, the associated threads of the screws are sealed.

FIG. 1 shows that the outer ring 12 has a longitudinal hole 40, the hole 40 opening out at the first face 16 of the rolling-element bearing 10, at least one edge 42 of the outer ring 12 having a longitudinal mark 44, the hole 40 and the mark 44 of the outer ring 12 being separated by a first angle α. The hole 40 is parallel to the longitudinal axis of the rolling-element bearing 10. The edge 42 can be an outer peripheral surface of the bearing ring 20. The longitudinal mark 44 is a groove but, alternatively, it could be a series of dots, a colored marking, or any equivalent. In a non-limiting manner, the value of the first angle α is 0°, which means that the hole 40 and the mark 44 are both contained in a same longitudinal plane of the rolling-element bearing 10 containing the longitudinal axis of rotation. Nevertheless, the value of the first angle α could be different, for example a few degrees. In this case the hole 40 and the mark 44 would be offset angularly.

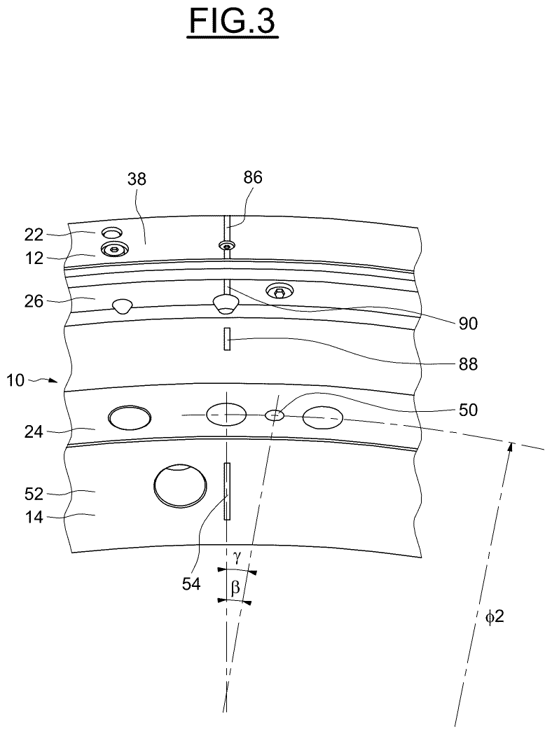

FIG. 3 shows that the inner ring 14 has a longitudinal hole 50 that opens at the second external face 18 of the rolling-element bearing 10. At least one edge 52 of the inner ring 14 has a longitudinal mark 54 that is circumferentially separated from the hole 50 by a second angle β. The hole 50 is parallel to the longitudinal axis of the rolling-element bearing 10. The edge 52 can be an inner peripheral surface of the bearing ring 24. The longitudinal mark 54 is a groove but, alternatively, it could be a series of dots, a colored marking, or any equivalent. In a non-limiting manner, the value of the first angle α is a few degrees, for example three degrees, which means that the hole 50 and the mark 54 are circumferentially offset.

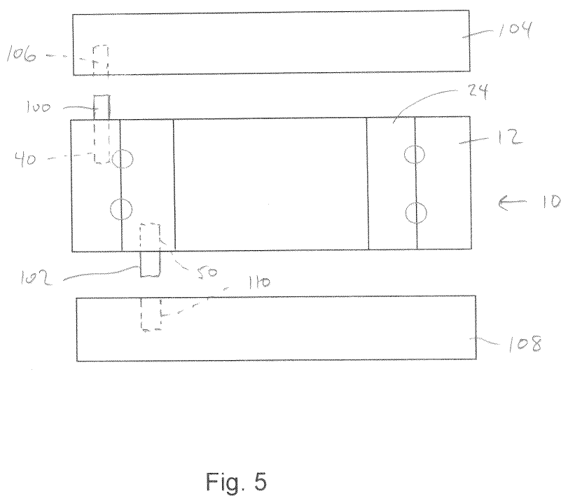

As will be appreciated from FIGS. 1-3, the hole 40 of the outer ring 12 and the hole 50 of the inner ring 14 are separated by a third angle γ when the marks 44, 54 of the outer ring 12 and the inner ring 14 are contained in a same longitudinal plane passing through the longitudinal axis. The angles α and β are measured according to the same direction of rotation, and the third angle γ is β minus a. Because the angles α and β are known, the third angle γ is also known. Accordingly, two pins 100, 102 (FIG. 5) each placed in a hole 40, 50 are separated by the known third angle γ. For example, in a non-limitative way, the value of third angle γ can be 3°.

As a result, the placing of each ring 12, 14 on a part of a device is easier. Effectively, each pin has a protruding part which is placed into a hole of the device. The two holes which receive the protrusions of the pins are offset by an angle value γ. This allows easy positioning of the outer 12 and inner 14 rings in the device. Thanks to the holes 40, 50 with pins, the angular position of the outer 12 and inner 14 rings is correct.

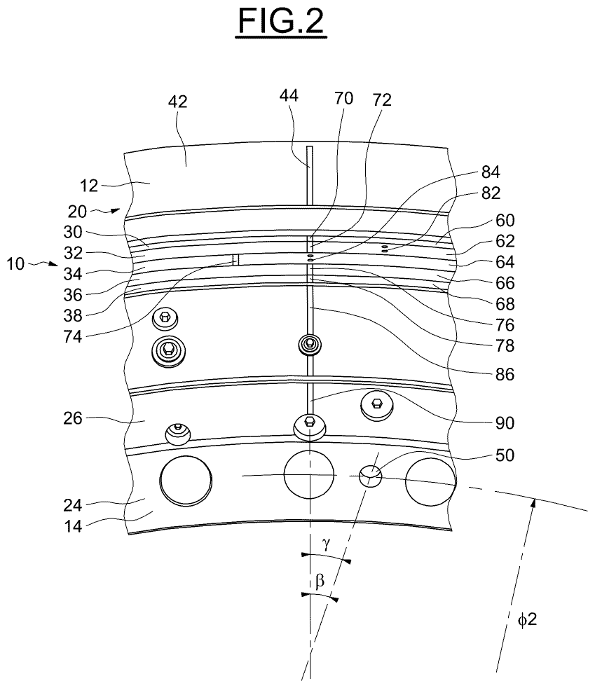

Always in the illustrated example, in view of FIGS. 1 and 2, each ring part 30, 32, 34, 36, 38 has a longitudinal through hole, not shown, located on a first diameter @1, each outer peripheral edge 60, 62, 64, 66, 68 of each ring part 30, 32, 34, 36, 38 having respectively a longitudinal mark 70, 72, 74, 76, 78, the through hole and the mark of an outer peripheral edge being separated by the first angle α.

The first bearing ring 20 of the outer ring 12 has a longitudinal through hole, not shown, located on the first diameter @1. The outer peripheral edge 42 of the first bearing ring 20 has the longitudinal mark 44 as seen before, and the through hole and the mark 44 of the outer peripheral edge 42 are separated by the first angle α. All of the through holes in the ring parts 30, 32, 34, 36, 38 and the through hole in the first bearing ring 20 are aligned and form the hole 40 opening out at the first face 16 of the rolling-element bearing 10 when all the marks 70, 72, 74, 76, 78, 44 of the ring parts 30, 32, 34, 36, 38 and the first bearing ring 20 are aligned. As a result, a pin prevents all rings from rotating relative to each other when the pin is in place in the hole 40 opening out at the first face of the rolling-element bearing.

In a non-limiting manner, two of the intermediate rings 32, 34 are twin rings having the same design. In other words, the twin rings 32, 34, have the same structure. Each twin ring 32, 34 has two longitudinal through holes, the two through holes being on the first diameter Ø1 and being separated by the third angle γ. Each twin ring 32, 34 respectively has the first mark 72, 74 at the level of one of the through holes and a second mark 82, 84 at the level of the other of the through holes, the twin rings 32, 34 being adjacent and offset. This simplifies the structure of the rolling-element bearing.

FIG. 2 shows that the end ring 38 of the first sealing ring assembly 22 has a radial mark 86 contained in a longitudinal plane passing through the longitudinal axis, the longitudinal plane containing the mark 78 of the outer peripheral edge 68 of the end ring 38.

FIG. 3 shows that the second sealing ring assembly 26 of the inner ring 14 has one longitudinal mark 88 and the second bearing ring 24 of the inner ring 14 has one longitudinal mark 54, the mark 54 being the longitudinal mark of the inner ring 14 seen before. Both longitudinal marks 88, 54 are contained in a longitudinal plane passing through the longitudinal axis, the hole 50 opening out at the second face 18 of the rolling-element bearing 10 being on a second diameter @2, the hole 50 and the two longitudinal marks 88, 54 being separated by the second angle β. Accordingly, the position of a pin in place in the hole 50 opening out at the second face 18 is known.

The second sealing ring assembly 26 of the inner ring 14 has a radial mark 90 contained in the longitudinal plane which contains the longitudinal marks 88, 54.

The angle value a is 0°, the angle value B is 3°, and the angle value γ is 3°. With these values, very good results have been obtained.

FIG. 5 shows the rolling-element bearing 10 placed between a first device 104 having an opening 106 and a second device 108 having an opening 110. The holes 40, 50 of the rolling element bearing, and therefore the pins 100, 102 in the holes 40, 50 are angularly spaced by the third angle γ because the longitudinal marks 44, 54 (not visible in FIG. 5) are aligned. This allows the rolling element bearing to be attached between the first device 104 and the second device 108 by inserting the pin 100 into the opening 106 of the first device 104 and inserting the pin 102 into the opening 110 of the second device 108. In an alternate embodiment, the pins 100, 102 could project from the same axial side of the rolling-element bearing 10 if the first device 104 is provided with two suitably spaced openings.

In the described example, the rolling-element bearing 10 comprises two rows of rolling elements. Alternatively, the rolling-element bearing 10 may comprise only one row of rolling elements, or three or more rows of rolling elements. The rolling elements can be balls, rollers, or else.

All marks are grooves, but could alternately be color marks, ribs, rows of dimples, or other similar indicia.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved rolling-element bearing assemblies.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A rolling-element bearing comprising:
an outer bearing ring having a first axial end face, a second axial end face and a cylindrical outer surface,
an inner bearing ring arranged relative to the outer ring for relative rotation about a common longitudinal axis and having a first axial end face, a second axial end face and a cylindrical inner surface, and
at least one row of rolling elements between the outer ring and the inner ring,
wherein the outer bearing ring includes a longitudinal hole extending into the first axial end face of the outer bearing ring,
wherein the cylindrical outer surface of the outer bearing ring includes a longitudinal mark,
wherein the longitudinal hole of the first bearing ring and the longitudinal mark of the first bearing ring are separated by a first angle α,
wherein the inner bearing ring includes a longitudinal hole extending into the inner bearing ring from the second axial end face of the inner bearing ring,
wherein the cylindrical inner surface of the inner bearing ring includes a longitudinal mark,
wherein the longitudinal hole of the inner bearing ring is separated from the longitudinal mark of the inner bearing ring by a second angle β, and
wherein the hole of the outer bearing ring and the hole of the inner bearing ring are separated by a third angle γ when the longitudinal mark of the outer bearing ring and the longitudinal mark of the inner bearing ring are contained in a same longitudinal plane passing through the longitudinal axis.

2. A method comprising:
placing a first pin in the longitudinal hole of the outer bearing ring so that a portion of the first pin projects from the first axial end face of the outer bearing ring,
placing a second pin in the longitudinal hole of the inner bearing ring so that a portion of the second pin projects from the second axial end face of the inner bearing ring,
positioning the outer bearing ring and the inner bearing ring such that the longitudinal mark of the outer bearing ring and the longitudinal mark of the inner bearing ring are contained in a same longitudinal plane passing through the longitudinal axis, and
while maintaining the longitudinal mark of the outer bearing ring and the longitudinal mark of the inner bearing ring in the same longitudinal plane, positioning the rolling-element bearing between a first structure adjacent the first axial end face of the outer bearing ring and a second structure adjacent the second axial end surface of the inner bearing ring and inserting the first pin into a hole in the first structure and the second pin into a hole in the second structure.

3. A rolling bearing comprising an outer ring and an inner ring configured to rotate concentrically relative to one another about a longitudinal axis, at least one row of rolling elements being arranged between the outer and inner rings, the rolling bearing having a first external face and a second external face axially opposite to the first external face which delimit an axial length of the bearing,
wherein the outer ring has a longitudinal hole opening at the first external face of the rolling bearing,
wherein at least one edge of the outer ring has a longitudinal mark,
wherein the hole of the outer ring and the mark of the outer ring are separated by a first angle α,
wherein the inner ring has a longitudinal hole opening at the second external face of the rolling bearing,
wherein at least one edge of the inner ring has a longitudinal mark,
wherein the hole of the inner ring and the mark of the inner ring are separated by a second angle β, and
wherein the hole of the outer ring and the hole of the inner ring are separated by a third angle γ when the mark of the outer ring and the mark of the inner ring are contained in a same longitudinal plane passing through the longitudinal axis.

4. The rolling bearing according to claim 3,
wherein the outer ring comprises at least one first bearing ring and at least one first sealing ring secured to the at least one first bearing ring, and
wherein the inner ring comprises at least one second bearing ring and at least one second sealing ring secured to the at least one second bearing ring.

5. The rolling bearing according to claim 4,
wherein the first sealing ring of the outer ring is formed as a split ring and comprises at least two part rings,
wherein one of the at least two parts rings farthest from the bearing ring is an end ring,
wherein the at least two part rings have a longitudinal through hole located on a first diameter and an outer peripheral edge having a longitudinal mark,
wherein the through hole and the mark of the outer peripheral edge are separated by the first angle α,
wherein the first bearing ring of the outer ring has a longitudinal through hole located on the first diameter,
wherein an outer peripheral edge of the first bearing ring has a longitudinal mark,
wherein the through hole and the mark of the outer peripheral edge are separated by the first angle α, and
wherein all of the through holes in the part rings and the through hole in the first bearing ring are aligned and form the hole opening at the first face of the rolling bearing when all the marks of the part rings and the first bearing ring are aligned.

6. The rolling bearing according to claim 5,
wherein two of the part rings are twin rings having the same design, each twin ring having two longitudinal through holes, the two through holes being on the first diameter and being separated by the third angle γ, each twin ring having a first mark at the level of one of the through holes and a second mark at the level of the other of the through holes, the twin rings being adjacent and offset.

7. The rolling bearing according to claim 6,
wherein the end ring of the first sealing ring has a radial mark contained in a longitudinal plane passing through the longitudinal axis, the longitudinal plane containing the mark of the outer peripheral edge of the end ring.

8. The rolling bearing according to claim 7,
wherein the first sealing ring of the outer ring includes five part rings.

9. The rolling bearing according to claim 8,
wherein the second sealing ring of the inner ring has one longitudinal mark,
wherein the second bearing ring of the inner ring has one longitudinal mark,
wherein the at least one longitudinal mark of the second sealing ring and the at least one longitudinal mark of the second bearing ring are contained in a longitudinal plane passing through the longitudinal axis,
wherein the hole opening at the second face of the rolling bearing is on a second diameter, and
wherein the hole and the at least one longitudinal mark of the second sealing ring and the at least one longitudinal mark of the second bearing ring are separated by the second angle β.

10. The rolling bearing according to claim 9, wherein the second sealing ring of the inner ring has a radial mark contained in the longitudinal plane which contains the longitudinal marks.

11. The rolling bearing according to claim 10,
wherein the first angle α is 0°,
wherein the second angle β is 3°, and
wherein the third angle γ is 3°.

12. A method of mounting method a rolling bearing according to claim 3 comprising:
placing a pin in the longitudinal hole of the outer ring so that the pin protrudes,
placing another pin in the longitudinal hole of the inner ring so that the pin protrudes,
positioning the outer ring relative to the inner ring so that their respective marks are contained in a same longitudinal plane passing through the longitudinal axis,
securing one of the outer and inner rings to a rotating device, the projecting part of a pin taking place in an orifice of the device, and
securing the other of the outer and inner rings to another rotating device, the projecting part of the pin taking place in an orifice of the device.
